(19) United States
(12) Patent Application Publication
(10) Pub. No.: US 2009/0044186 A1
(43) Pub. Date: Feb. 12, 2009

(54) SYSTEM AND METHOD FOR IMPLEMENTATION OF JAVA AIS API

(75) Inventor: Jozsef Biro, Budapest (HU)

Correspondence Address: Nokia, Inc., 6021 Connection Drive, MS 2-5-520, Irving, TX, 75039, US

(73) Assignee: Nokia Corporation

(21) Appl. No.: 11/835,326

(22) Filed: Aug. 7, 2007

(51) Int. Cl. G06F 9/455

(52) U.S. Cl. 718/1

(57) ABSTRACT

A computer system includes a cluster of one or more nodes corresponding to a processor and representing a first execution layer, the node being adapted to execute an application component; and an application interface adapted to model a virtual machine as a secondary node of the cluster operating as a second execution layer on the first execution layer; wherein the application interface is adapted to manage one or more non-virtual machine application components as application components executing on the first execution layer and one or more virtual machine application components as application components executing on the second execution layer.

### BACKGROUND OF THE INVENTION

The exemplary embodiments of this invention relate generally to the field of computer systems and, more specifically, to the field of Application Program Interface (API) for accommodating virtual machine execution.

Java is not suitable as a software development and deployment platform for carrier grade products in its current state. Neither Java Standard Edition(SE) nor Java Enterprise Edition (EE) has a proper standard answer for systems that require non-functional qualities such as high-availability, high-reliability and high performance.

The Service Availability Forum (SAF, see www.saforum.org) is a consortium of communications and computing companies working together to develop and publish high availability and management software interface specifications, including the Application Interface Specification (AIS) for Java. AIS is one of the specifications supported by SAF. AIS standardizes the interface between an SAF-compliant high-availability (HA) middleware and service applications that exploit the middleware to achieve high availability.

The latest version of the AIS specification, version B.02.01, was published at the beginning of 2006 and is available at “www.saforum.org/specification/ais_information”. The specification is hereby incorporated by reference in its entirety for all purposes.

AIS is an API specification that defines a programming model for service applications written in the C programming language. AIS is not currently available in Java and, due to the fundamental differences between C and Java, there is no straightforward way to support AIS in Java. Despite this fact, it is desirable to combine the benefits of Java and a standard framework, such as AIS, supporting High Availability(HA) applications.

### SUMMARY OF THE INVENTION

One aspect of the invention relates to a computer system comprising a cluster of one or more nodes corresponding to a processor and representing a first execution layer, the node being adapted to execute an application component; and an application interface adapted to model a virtual machine as a secondary node of the cluster operating as a second execution layer on the first execution layer; wherein the application interface is adapted to manage one or more non-virtual machine application components as application components executing on the first execution layer and one or more virtual machine application components as application components executing on the second execution layer.

In one embodiment the application interface includes a first interface subsystem operating on the first execution layer and a second interface subsystem operating on the second execution layer, the first interface subsystem adapted to manage non-virtual machine application components, the second interface subsystem adapted to manage virtual machine application components.

In another embodiment, the second interface subsystem is adapted to interface the virtual machine application component with the first interface subsystem for non-virtual machine functionality.

The second interface subsystem may include a secondary node manager adapted to manage lifecycle of each secondary node on the node.

In one embodiment, the application interface includes a cluster membership service adapted to manage information relating to nodes and secondary nodes in the cluster. The cluster membership service may classify a secondary nodes as a node. The cluster membership service may distinguish between a node and a secondary node as different node types.

In another aspect, the invention includes a method of interfacing a computer system with an application, the computer system comprising a cluster of one or more nodes. The method comprises modeling each node of the cluster as a first execution layer adapted to execute an application component; modeling a virtual machine as a secondary node of the cluster operating as a second execution layer on the first execution layer; managing one or more non-virtual machine application components as application components executing on the first execution layer; and managing one or more virtual machine application components as application components executing on the second execution layer.

In another aspect of the invention, a node for a computer system includes a first execution layer adapted to execute one or more non-virtual machine application components and including one or more interfaces. The node further includes one or more virtual machines modeled on the first execution layer as secondary nodes and adapted to execute one or more virtual machine application components. Each secondary node includes a secondary node manager and one or more interfaces for interfacing the secondary node with the first execution layer.

### BRIEF DESCRIPTION OF THE DRAWINGS

FIG. 1 is a unified modeling language (UML) class diagram illustrating certain logical entities associated with an availability management framework (AMF);

FIG. 2 is a UML deployment diagram illustrating an implementation of the Application Interface Specification (AIS) for the AMF of FIG. 1;

FIG. 3 is a UML class diagram illustrating certain logical entities associated with an AMF including a secondary node according to an embodiment of the invention;

FIG. 4 is a UML deployment diagram illustrating an exemplary node having a secondary node thereupon according to an embodiment of the invention;

FIG. 5 is a UML deployment diagram illustrating the node of FIG. 4 in greater detail;

FIG. 6 is a block diagram illustrating an exemplary operation of a system operating according to an embodiment of the invention; and

FIG. 7 is a flow chart illustrating the updating of the cluster membership for systems with a secondary-node capability.

### DETAILED DESCRIPTION OF THE CERTAIN EMBODIMENTS

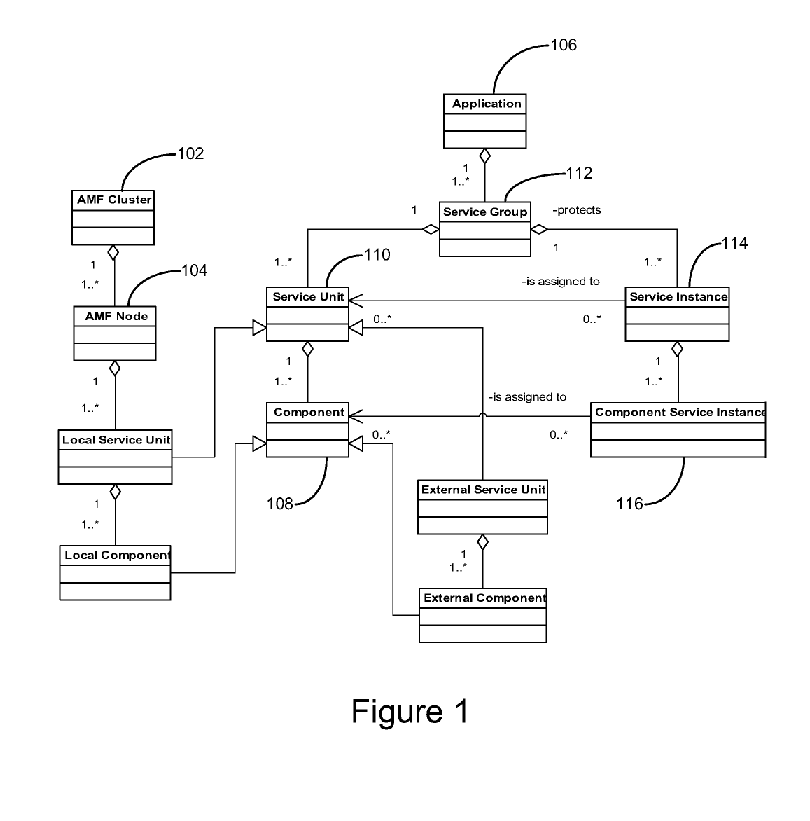

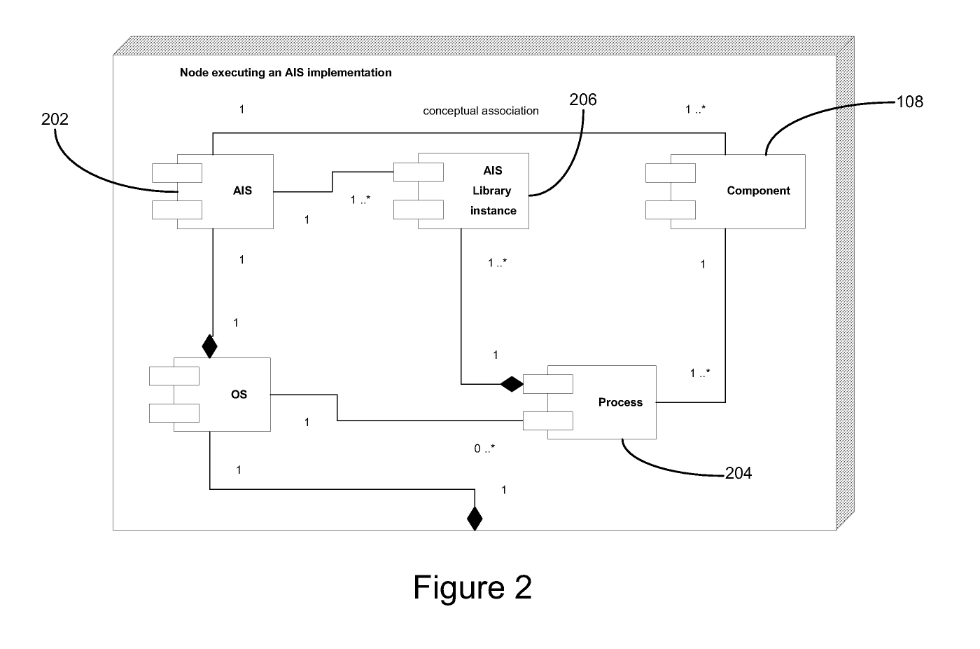

In order to describe various embodiments of the present invention, it is helpful to have an understanding of the AIS. Accordingly, the AIS is first described with reference to FIGS. 1 and 2.

As mandated by AIS, an SAF-compliant HA middleware contains several major elements. These include an availability management framework (AMF), a cluster membership service, a checkpoint service, an event service, a message service, a lock service, an information model management service, a log service and a notification service.

The AMF is the software entity that provides service availability by coordinating redundant resources within a cluster to deliver a system with no single point of failure. The AMF is described below in greater detail with reference to FIG. 1.

The cluster membership service maintains membership information about the nodes. The checkpoint service provides a facility for processes to record checkpoint data incrementally, which can be used to protect an application against failures. The event service is a publish/subscribe multipoint-to-multipoint communication mechanism that is based on the concept of event channels. One or more publishers may communicate asynchronously with one or more subscribers via events over a cluster-wide entity, named “event channel.” The message service provides a communication mechanism for processes on the same or on different nodes. Messages are written to and read from message queues. The lock service is a distributed lock service intended for use in a cluster where processes in different nodes may compete with each other for access to a shared resource. The information model management service manages the SAF information model. The different entities of an AIS cluster, such as components provided by AMF, checkpoints provided by the checkpoint service, or message queues provided by the message service are represented by various objects of the SAF information model. The log service provides high-level, cluster-significant, function-based information suited primarily for network or system administrators, or automated tools to assist troubleshooting issues, such as mis-configurations, network disconnects and unavailable resources. Finally, the notification service is provided for system management purposes and is used by a service user to report an event to a peer service user. The list of services is extensible and may be expanded in the future to include additional services.

One element of the AIS middleware is AMF, which supports various redundancy models for applications. AMF defines a system model consisting of the several key logical entities. FIG. 1 is a unified modelling language (UML) class diagram illustrating some of the logical entities associated with AMF, as well as with embodiments of the present invention. AMF includes an AMF cluster 102 which may include one or more AMF nodes, such as AMF node 104. As illustrated in FIG. 1, an AMF cluster 102 may be configured to include one or any practical number of AMF nodes 104. Each AMF node is a logical representation of a physical node (e.g., a computer, a laptop, a desktop or any unit with a processor such as a central processing unit (CPU)) that can run a single instance of an operating system and export AIS APIs.

An AMF cluster has several characteristics. For example, the one or more nodes, such as AMF node 104, can be configured as members of the AMF cluster 102. Further, each node can provide adequate support to run a particular application. All nodes within the AMF cluster 102 are capable of communicating with each other. Finally, all nodes within the AMF cluster 102 are managed by a single AMF.

An application 106 to be executed on the AMF cluster 102 is organized as a set of components 108. Again, as illustrated in FIG. 1, an application may be divided into one or any practical number of components 108. Each component 108 represents the smallest entity on which the AMF performs error detection and recovery. Thus, a component 108 should include all functions that cannot be clearly separated for error containment or isolation purposes. A component is ideally composed of one operating system process, but may include more processes as well. In this manner, AMF can exploit the isolation provided by an operating system process to ensure the required isolation of AIS Components.

Due to the isolation requirement, the AIS component model is a very coarse-grained model and is naturally different from component models offered by object-oriented application frameworks. Thus, if such an object-oriented application is to be combined with AIS to create an HA application, then there should be a clear distinction between the native component model of the application and the AIS Components.

On a conceptual level, the AIS middleware sees the application as a set of components. In practice, as illustrated in FIG. 2, the AIS 202 communicates with the process(es) 204 of the components 108, using the library instances 206. Library instances 206 are dynamic associations between the processes 204 and the AIS implementation 202. AIS is able to support more library instances for each process if required.

Referring again to FIG. 1, components 108 are combined into service units 110. A service unit 110 represents a higher level service and also provides a simplified coarser grained view of the application for system administrators.

AIS provides a redundancy model by organizing several identical service unit instances into service groups 112. Depending on the selected model (2N, N+M, N-way, N-way active are currently supported), the service group 112 may instantiate the necessary number of active and standby service units 110. While a particular service unit is always restricted to a single node, the service group 112 is usually distributed among several nodes. An application 106 is a logical entity that contains one or more service groups 112, combining the individual service group functionalities to provide a higher level service.

The workload of the application 106 can be dynamically changed according to the actual state of the cluster 102. The smallest unit of the workload is defined as a component service instance 116 which can be assigned to components 108. These pieces of workload can be combined into a higher level represented by service instances 114 that can be assigned to service units 110.

As noted above, AIS is not currently available in Java and, due to the fundamental differences between C and Java, there is no straightforward way to support AIS in Java. Embodiments of the present invention provide for implementations of AIS-compliant middleware supporting Java applications.

One of the key technical problems in creating the Java support for AIS is the placement of the Java Virtual Machine (JVM) in the system model of the AMF, described above with reference to FIGS. 1 and 2.

A JVM introduces a second layer of execution. On the one hand, it is an application (typically a single process) executed by the operating system. On the other hand, it is an execution environment itself, executing Java applications. Furthermore, the Java applications are invisible to the operating system.

The VM may be mapped to a number of logical entities in the AIS. However, mapping of the VM to some of these entities places special requirements on the VM itself. For example, these special requirements may include 1) the number of supported Java applications and 2) the number of Nodes on which the VM is able to execute.

The standard VMs available on the market today as commercial off-the-shelf (COTS) products are targeted for a single computer, running a single operating system process and supporting a single Java application. The usage of such a VM in AIS is limited by the fact that AIS requires that components need to be separated from other components for error containment purposes.

Existing approaches for the mapping of the VM treat the VM as a special component type, thus requiring substantial modification of the AIS. Embodiments of the present invention avoid this major drawback.

As described above, a component as defined by AIS represents an application entity. A component is an actual piece of code written by the developer of an HA application, and it implements application functionality. A VM, however, is not an application entity by nature. Instead, it is an entity that provides an execution environment for applications.

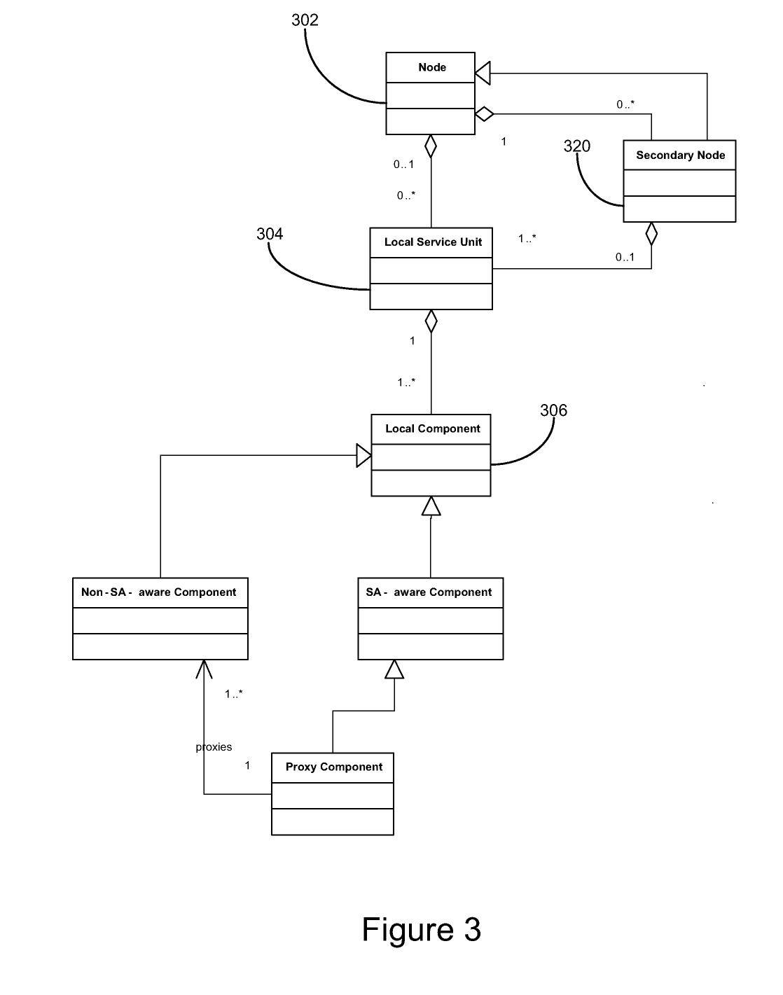

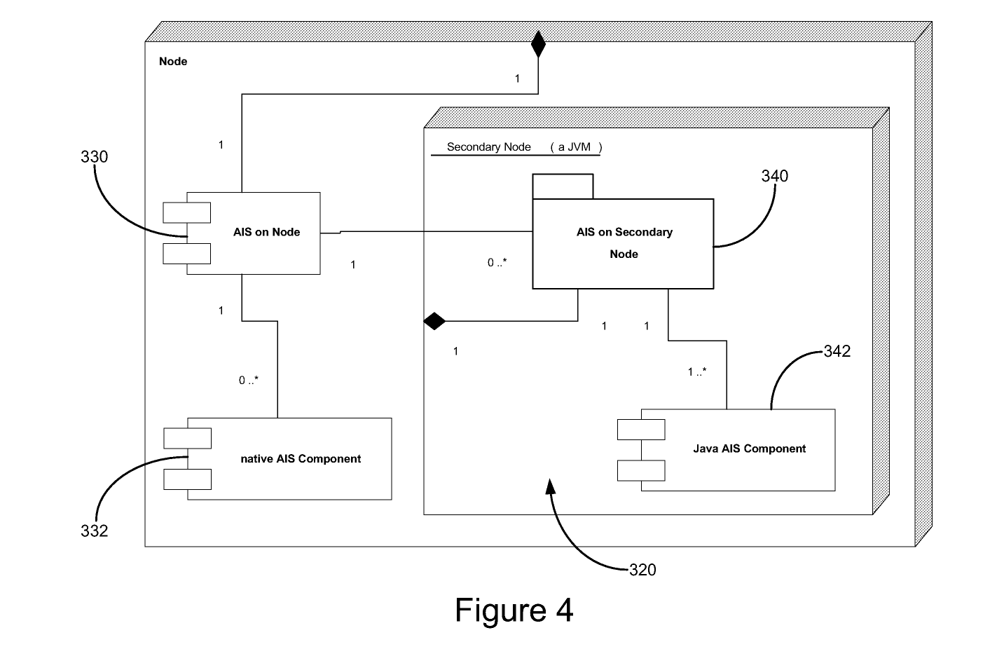

According to embodiments of the present invention, an additional logical entity is introduced to the AMF system model to properly model the double nature of the VM. The additional logical entity is a Secondary Node. FIG. 3 is a UML class diagram illustrating an embodiment of an AIS with a secondary node, and FIG. 4 illustrates a high-level design view of a node with a secondary node according to an embodiment of the invention.

The AMF includes a node 302 which contains at least one local service unit 304 or secondary node 320, but may contain one or more of each. The node 302 represents a first execution layer, and the secondary node 320 represents a second execution layer on the node 302, as illustrated in FIG. 4. A local service unit 304 belongs to an execution environment. Thus, each local service unit 304 belongs to either the node 302 or the secondary node 320. Each local service unit belonging to a node represents an application implemented in C or other C-compatible native language. As a second execution layer, the secondary node may contain one or more local service units, each representing applications implemented in Java.

As implemented, the secondary node 320 is modeled very similarly to the node 302. For example, like the node 302, the secondary node is a part of the AIS implementation and is managed by AMF, as a subtype of a node 302.

With the addition of the secondary node as a logical entity, the AIS APIs require only limited modifications. The AIS APIs are configured for components. Since the notion of components is not changed by the addition of the secondary node, the APIs are not greatly affected.

In one embodiment, the cluster membership service, which informs its clients about nodes joining or leaving the cluster provides information on any secondary nodes introduced to the cluster. The cluster membership service may track the secondary nodes as a separate entity type from the nodes or may consider them the same entity type.

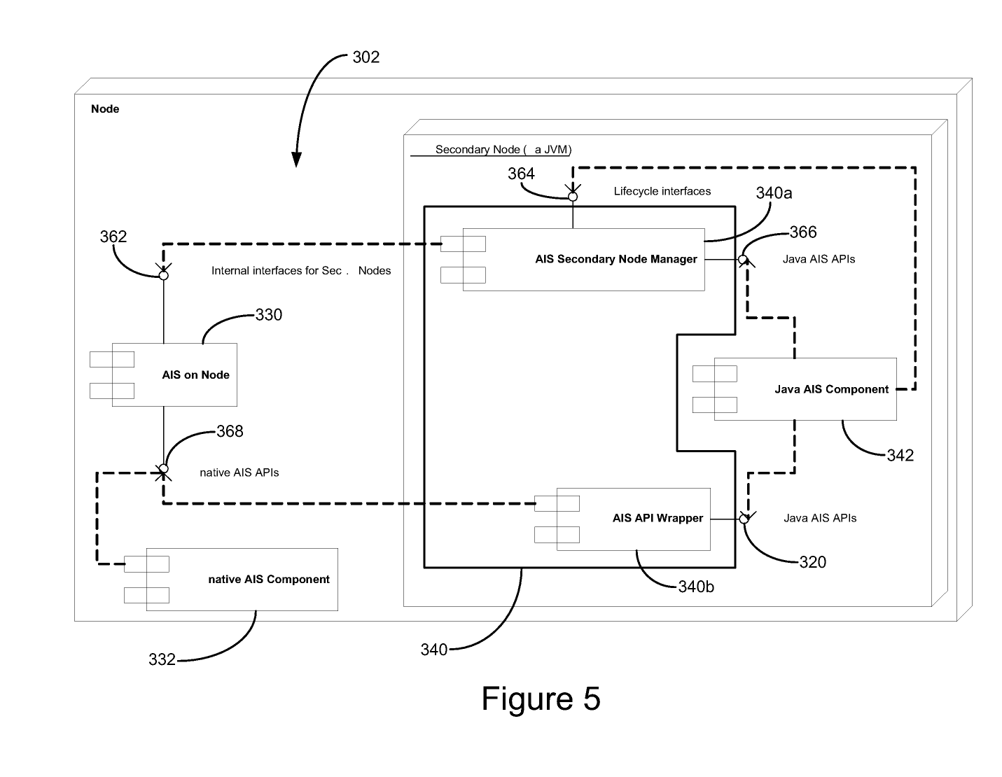

Referring now to FIG. 4, a UML deployment diagram illustrates an exemplary node having a secondary node thereupon. Since the node 302 and the secondary node 320 represent two separate execution layers, the AIS implementation is present in both layers. In this regard, the AIS implementation may include two subsystems, one on the node 330 and one on the secondary node 340. The two subsystems can communicate with each other using internal interfaces, as described below with reference to FIG. 5.

Since a node 302 may host several secondary nodes 320, the AIS on the secondary node subsystem 340 may have several instances, one for each secondary node 320. Since the AIS implementation allows the coexistence of native AIS components 332 and Java AIS components 342, both subsystems 330, 340 can be associated with AIS components 332, 342 executing in their respective execution layer.

In one embodiment, the AIS subsystem 330 on the node 302 is a slightly extended version of a baseline AIS system not having a secondary node capability. Thus, most of the functionality mandated by the AIS can be allocated on the subsystem 330 on the node 302. The subsystem 340 on the secondary node can be a relatively small wrapper that propagates calls between the subsystem 330 on the node and the components, such as the Java AIS component 342, on the secondary node 320. Certain functions can be allocated to the subsystem 340 on the secondary node 320, such as functions that are provided by the local execution layer.

It is noted that other implementation strategies where the secondary node subsystem gets more responsibility are also contemplated within the scope of the invention.

FIG. 5 is a UML deployment diagram illustrating a more elaborated view of the AIS subsystem 340 on the secondary node 320 and a more detailed view of the internal and external interfaces in the implementation described above. The AIS subsystem 340 includes a secondary node manager 340a and an AIS API wrapper 340b. The secondary node manager 340a is adapted to manage the lifecycle of Java AIS components (e.g., starting, stopping, cleaning up in case of a failures) and to provide APIs that are based on services provided by the execution environment of the secondary node 320. The AIS API wrapper 340b is adapted to propagate public API calls between Java AIS components 342 and the AIS node subsystem 330.

As noted above, FIG. 5 illustrates various internal interfaces required for the management of the second execution layer formed by the secondary node 320. The AIS subsystem 330 on the node 302 provides internal interfaces 362 used by the AIS subsystem 340 on the secondary node 320. The internal interfaces 362 may include interfaces necessary for lifecycle management of the secondary node 320. For example, the lifecycle management of the secondary node 320 may include starting or stopping of the VM and the secondary node subsystem, as well as cleanup operations in case of failure of a secondary node.

The internal interfaces 362 may also include interfaces for lifecycle management of AIS components 342 executed by the secondary node 342 (e.g., commands that instruct the secondary node subsystem to start, stop or cleanup those components).

The internal interfaces 362 may also include interfaces specific to services provided at least partly through the execution environment of the secondary node 320. These services may be initiated by the AIS subsystem 330 on the node or by the AIS subsystem 340 on the secondary node 320. In the latter case, these interfaces may not be necessary or may be restricted to notifications towards the node subsystem (e.g., for archiving).

The AIS subsystem 340 on the secondary node 320 provides lifecycle interfaces as well. In this regard, the secondary node manager 340a provides a lifecycle management interface 364 for AIS components 342 on the secondary node 320. Through this interface 364, AIS components 342 can be started, stopped or cleaned-up.

The lifecycle management interfaces 364 provided by the secondary node manager 340a may be modified and adapted to accommodate the application model used for the Java AIS components 342 by the Java execution environment, as well as to accommodate the level of isolation between components 342. For example, using a multi-application VM, the lifecycle management interface may be based on the Isolate API (Java Specification Request 121) specified in the AIS specification, version B.02.01. When using a standard VM with a container framework, this interface will be determined by the specifics of the container framework.

The secondary node manager 340a further provides an API 366 specific to the secondary node execution environment (e.g., a Java API) that is based on services provided locally by the secondary node execution environment.

The AIS subsystem 330 on the node 302 provides native APIs 368 used directly by native AIS components 332.

The same APIs 368 are also intended for AIS components 342 on the secondary node 320. However, for the secondary node 320, due to the separated execution environment, the AIS components 342 cannot directly access the APIs 368. Instead the AIS API wrapper 340b accesses these APIs 368 and propagates the calls to the AIS components 342 by providing an API 370 specific to the secondary node execution environment (e.g., a Java API). Thus, AIS components 342 on the secondary node access the functionality offered by the AIS subsystem 330 on the node 302 by using these APIs 370.

From the point of view of the AIS components 342 on the secondary node 320, there is no difference between the APIs provided by the AIS API wrapper 340b and the secondary node manager 340a. The AIS components 342 see one uniform Java AIS API and are not aware of the particular subsystem providing particular functionalities of the API.

The internal interfaces 362 provided by the AIS subsystem 330 on the node 302 may or may not be public. A vendor may decide to offer an AIS implementation packaged together with a VM and a proprietary secondary node subsystem, in which case these interfaces will not be public. Another possibility is that an AIS vendor uses public interfaces between the two subsystems and allows VM and container framework vendors to integrate their products with its AIS implementation. This second possibility recognizes the fact that AIS implementation vendors and Java vendors come from different domains and is clearly more flexible (and favorable) from the customers' point of view.

Use of the secondary node allows the implementation of AIS compliant Java applications using VMs that execute multiple Java AIS components. This allows mapping of a single VM to a whole Node or to a one or more Service Units. These mappings require less VM instances than mappings using a single-application VM (i.e., one VM per component/process). Thus, the memory footprint required by Java components is significantly reduced.

If we compare the proposed Secondary Node with other available solutions supporting multiple Java AIS Components within a VM (namely, the Proxy approach and the Container Component approach) the main advantage of the proposed Secondary Node approach that it eases the configuration of Java applications for AIS.

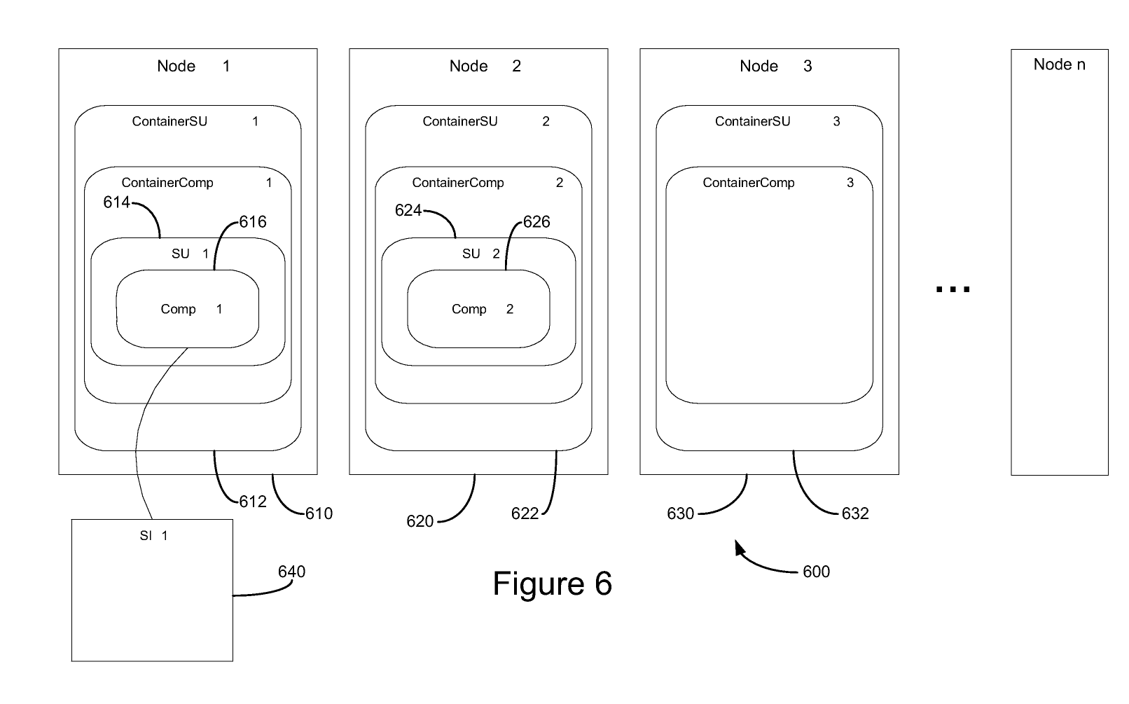

An exemplary operation of a system implementing secondary-node capability will now be described with reference to FIG. 6. In one embodiment, the API only needs to be aware of the placement of the secondary nodes. Since the secondary nodes are treated substantially as nodes, no other treatment specific to secondary nodes is required.

FIG. 6 illustrates a system having a plurality of nodes, Node 1 to Node n. For purposes of clarification, the illustration of FIG. 6 has been simplified, and certain AMF system model entities, such as service instances, are not shown. Node 1-3 610, 620, 630 each have a second execution layer (a VM) running thereupon and represented as secondary nodes 612, 622, 632. Java components 616, 626 and service units 616, 626 are assigned to Node 1 612 and Node 2 622.

Each VM 612, 622, 632 is active, as the AMF implementation implicitly handles them in a 3-way active redundancy mode. In the example of FIG. 6, the 3-way active redundancy mode is identical to a 2+1 mode, since the third VM 632 has not been assigned any service units (e.g., Java components). The third VM 632 operates in standby mode.

The workload for the Java components 616, 626 is represented by component service instance 640. In this regard, the Java component 616 on Node 1 610 is active for the workload of the component service instance 640, as indicated by the solid line between the component service instance 640 and the Java component 616. Conversely, the Java component 626 on Node 2 620 is the standby component for the workload of the component service instance 640, as indicated by the dashed line between the component service instance 640 and the Java component 626. In this regard, the Java components 616, 626 operate in a 1+1 redundancy model.

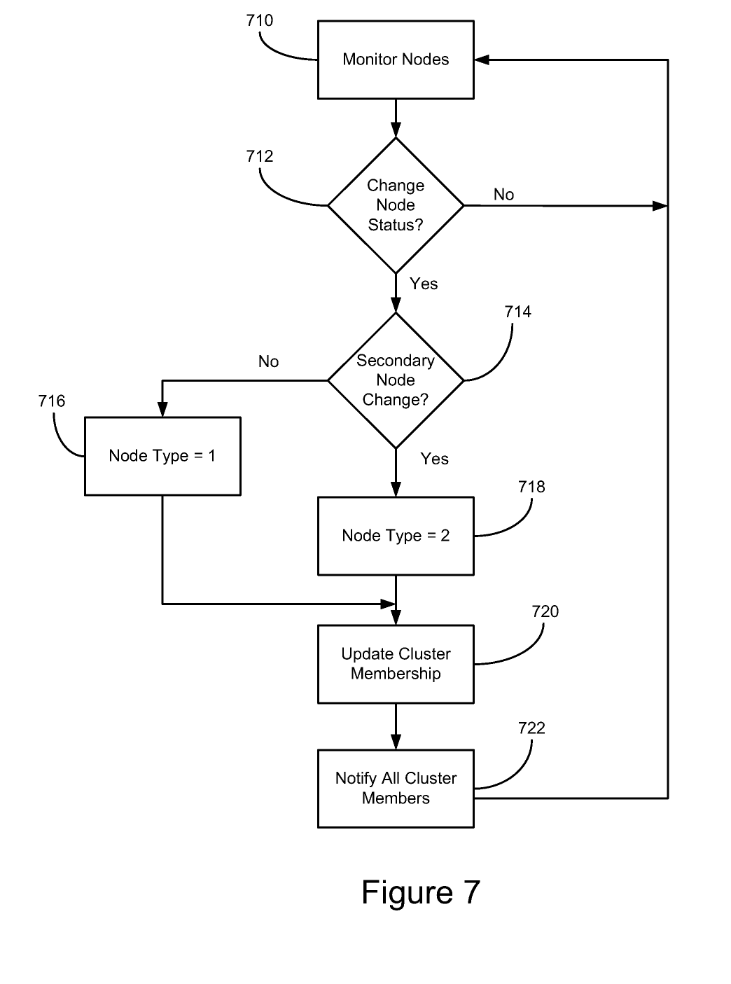

Now, with reference to FIG. 7, the operation in managing cluster membership of a system with a secondary-node capability will be described. At step 710, the nodes are monitored for any changes in operation of the nodes. This may include availability of nodes, including secondary nodes. At step 712, if a change in the status of a node is detected, it is determined whether the changed node is a secondary node at step 714. Based on the determination, a node type is assigned to the changed node as either a node or a secondary node (steps 716 and 718). In this regard, the node type may be indicated in any of a number of ways. In the embodiment illustrated in FIG. 7, a node is assigned a NodeType value of 1, while a secondary node is assigned a NodeType value of 2.

The cluster membership for the system is then updated (step 720) to reflect the change in the status of nodes. The change may reflect the availability and type of nodes available in the cluster. For secondary nodes, the change may also reflect the placement of the secondary node by indicating the node on which the secondary node is executing. At step 722, the notification service notifies all cluster members of the change in node status. The process then returns to step 710 and continues monitoring of the nodes.

Thus, embodiments of the present invention provide systems and methods for accommodating Java applications on an AIS-compliant system without significant changes to the AIS.

While particular embodiments of the present invention have been disclosed, it is to be understood that various different modifications and combinations are possible and are contemplated within the true spirit and scope of the appended claims. There is no intention, therefore, of limitations to the exact abstract and disclosure herein presented.

What is claimed is:

1. A computer system, comprising:
a cluster of one or more nodes corresponding to a processor and representing a first execution layer, the node being adapted to execute an application component; and
an application interface adapted to model a virtual machine as a secondary node of the cluster operating as a second execution layer on the first execution layer;
wherein the application interface is adapted to manage one or more non-virtual machine application components as application components executing on the first execution layer and one or more virtual machine application components as application components executing on the second execution layer.

2. The computer system of claim 1, wherein the application interface includes a first interface subsystem operating on the first execution layer and a second interface subsystem operating on the second execution layer, the first interface subsystem adapted to manage non-virtual machine application components, the second interface subsystem adapted to manage virtual machine application components.

3. The computer system of claim 2, wherein the second interface subsystem is adapted to interface the virtual machine application component with the first interface subsystem for non-virtual machine functionality.

4. The computer system of claim 2, wherein the second interface subsystem includes a secondary node manager adapted to manage lifecycle of each secondary node on the node.

5. The computer system of claim 1, wherein the application interface includes a cluster membership service adapted to manage information relating to nodes and secondary nodes in the cluster.

6. The computer system of claim 5, wherein the cluster membership service classifies a secondary nodes as a node.

7. The computer system of claim 5, wherein the cluster membership service distinguishes between a node and a secondary node as different node types.

8. A method of interfacing computer system with an application, the computer system comprising a cluster of one or more nodes, the method comprising:
modeling each node of the cluster as a first execution layer adapted to execute an application component;
modeling a virtual machine as a secondary node of the cluster operating as a second execution layer on the first execution layer;
managing one or more non-virtual machine application components as application components executing on the first execution layer; and
managing one or more virtual machine application components as application components executing on the second execution layer.

9. The method of claim 8, further comprising:
managing non-virtual machine application components with a first interface subsystem operating on the first execution layer and a second interface subsystem on the second execution layer, and
managing virtual machine application components with a second interface subsystem operating on the second execution layer.

10. The method of claim 9, further comprising:
interfacing the virtual machine application component with the first interface subsystem for non-virtual machine functionality through the second interface subsystem.

11. The method of claim 9, wherein the second interface subsystem includes a secondary node manager adapted to manage lifecycle of each secondary node on the node.

12. The method of claim 8, further comprising:
managing information relating to nodes and secondary nodes in the cluster.

13. The method of claim 12, further comprising:
classifying a secondary nodes as a node.

14. The method of claim 12, further comprising:
distinguishing between a node and a secondary node as different node types.

15. A node for a computer system, comprising:
a first execution layer adapted to execute one or more non-virtual machine application components and including one or more interfaces; and
one or more virtual machines modeled on the first execution layer as secondary nodes and adapted to execute one or more virtual machine application components, each secondary node comprising:
a secondary node manager; and
one or more interfaces for interfacing the secondary node with the first execution layer.

16. The node of claim 15, wherein the one or more interface of the first execution layer are adapted to manage non-virtual machine application components, and wherein the one or more interfaces of the secondary node are adapted to manage virtual machine application components.

17. The node of claim 16, wherein the one or more interfaces of the secondary node are adapted to interface the virtual machine application component with the one or more interfaces of the first execution layer for non-virtual machine functionality.

18. The node of claim 16, wherein the secondary node manager is adapted to manage lifecycle of each secondary node on the first execution layer.
